(19) United States
(12) Patent Application Publication
(10) Pub. No.: US 2023/0184559 A1
(43) Pub. Date: Jun. 15, 2023

(54) Correction Of An Estimate Of An Energy Consumption Of A Vehicle

(71) Applicant: Joynext GmbH, Dresden (DE)

(72) Inventor: Daniel Wedekind, Dresden (DE)

(21) Appl. No.: 17/979,896

(22) Filed: Nov. 3, 2022

(30) Foreign Application Priority Data
Dec. 13, 2021 (DE) 102021132807.1

(51) Int. Cl. G01C 21/34; G07C 5/00

(52) U.S. Cl. CPC G01C 21/3469; G07C 5/008

(57) ABSTRACT

The invention relates to a method for correcting an estimate of an energy consumption of a vehicle (306) for traveling a route segment (305) of a route network. In the method, an estimated energy consumption required for the vehicle (306) to travel the route segment (305) of a travel route (300) to be traveled by the vehicle (306) in the route network is calculated. The travel route (300) and additional data related to the vehicle (306) are transferred to a data cloud (307). In the data cloud (307), an estimated value for a deviation of the actual energy consumption of the vehicle (306) for traveling the route section (305) from the calculated expected energy consumption of the vehicle (306) required for traveling the route section (305) is determined. The calculated estimated energy consumption of the vehicle (306) required to travel the route segment (305) is corrected based on the estimated value.

The invention relates to a method and an energy consumption correction system for correcting an estimate of an energy consumption of a vehicle for traveling a section of a path network.

### BACKGROUND

Many newer model vehicles feature an energy control device that calculates, among other things, a predicted energy consumption of the vehicle on a route planned for the vehicle. This calculation is particularly helpful for an electric vehicle, i.e., a vehicle powered by electricity, because electric vehicles generally have a shorter range than comparable vehicles with an internal combustion engine. In addition, there are currently still relatively few charging stations available for electric vehicles at which energy storage devices (traction batteries) of electric vehicles can be charged.

The calculation of the expected energy consumption includes, for example, map data from a digital map from which, for example, road types and gradients along the driving route are taken, a driver profile of a driver of the vehicle, a vehicle occupancy of the vehicle and/or estimates of the energy demand of electrical consumers of the vehicle such as an audio system or an air conditioning system.

A route for a vehicle from a starting position to a destination position is often calculated using a route planner. A route planner is a computer program that is executed, for example, by a device located in the vehicle with a navigation function or in a data cloud. The destination position of a route is usually derived from a destination specified by a user of the route planner. Alternatively, the target position can also be estimated, for example from a driving history of the vehicle. The start position may also be derived from a specification provided by the user. Alternatively, the start position may be, for example, a current position of the vehicle. The position of the vehicle is usually determined using a navigation satellite system, for example using GPS, GLONASS, Beidou or Galileo.

The travel route can also be calculated as a function of the anticipated energy consumption. For example, the travel route can be calculated in such a way that the anticipated energy consumption is minimized. Alternatively, the travel route can, for example, be calculated in such a way that it enables refilling of an energy storage device, for example a fuel tank or a traction battery, of the vehicle along the travel route, for example if a filling level of the energy storage device is not sufficient to reach the target position.

However, the calculation of the expected energy consumption of a vehicle for travelling a driving route always has a limited accuracy, since not all parameters required for the calculation are known exactly. Therefore, the actual energy consumption required to travel a route always deviates to a greater or lesser extent from the calculated predicted energy consumption. The calculation of the expected energy consumption of a vehicle for travelling a route is therefore an estimate of the energy consumption with limited accuracy.

DE 10 2018 104 773 A1 discloses a method for determining a range of a motor vehicle or a hybrid motor vehicle based on route planning. In the method, the route is divided into a plurality of route intervals, and for each route interval, a route interval-specific interval energy demand is provided that is normalized to a predetermined distance unit and to a predefined weight. Using vehicle-specific data of the subject motor vehicle and the normalized interval energy requirements for the route, a total vehicle-specific energy requirement is then calculated.

DE 10 2018 203 975 A1 discloses a driver assistance method for a vehicle. The driver assistance method comprises generating an energy forecast for a route based on an anticipated driver behavior, determining an optimized driving behavior with respect to the energy forecast, and outputting a recommendation for action based on the optimized driving behavior.

### SUMMARY

The invention is based on the problem of correcting an estimate of an energy consumption of a vehicle for traveling a route segment to approximate an actual energy consumption of the vehicle for traveling the route segment.

The task is solved according to the invention with a method for correcting an estimate of an energy consumption of a vehicle for travelling a section of a route network, wherein:

an energy consumption expected to be required by the vehicle for travelling the section of a route travelled by the vehicle in the route network is calculated,

the route and additional data relating to the vehicle are transferred to a data cloud,

an estimated value for a deviation of the actual energy consumption of the vehicle for travelling the section of the route from the calculated energy consumption of the vehicle expected to be required for travelling the section of the route is determined in the data cloud, and

correcting the calculated expected energy consumption of the vehicle for traveling the route segment based on the estimated value.

In contrast, for example, to the prior art known from DE 10 2018 104 773 A1, the method according to the invention thus does not concern the actual calculation of an anticipated energy consumption of a vehicle for travelling a route section, but a correction for this calculation, i.e. a correction of an anticipated energy consumption calculated for the vehicle for travelling a route section. For this purpose, an estimated value for a deviation of the actual energy consumption of the vehicle for travelling the route section from the expected energy consumption calculated for the vehicle for travelling the route section is determined in a data cloud. This estimated value is then used as a correction value with which the estimated energy consumption calculated for the vehicle for travelling the route section is corrected.

The method according to the invention also differs fundamentally from the driver assistance method known from DE 10 2018 203 975 A1, which provides for determining a driving behavior optimized with respect to an energy forecast and outputting recommendations for action based on the optimized driving behavior. In other words, DE 10 2018 203 975 A1 aims at optimizing an energy consumption by a driving behavior based thereon, but not at correcting a calculation of a predicted energy consumption of a vehicle.

In one embodiment of the method according to the invention, the estimated value for the deviation of the actual energy consumption of the vehicle for travelling the route section from the calculated energy consumption of the vehicle expected to be required for travelling the route section is determined by a statistical evaluation of consumption data of vehicles transmitted to the data cloud and additional data related to these vehicles in each case. The consumption data describes the calculated energy consumption of a vehicle expected to be required for travelling a section of the route network and the actual energy consumption of the respective vehicle for travelling this section of the route.

According to the aforementioned embodiment of the method according to the invention, consumption data of a plurality of vehicles in a data cloud are thus statistically evaluated to determine the estimated value for the deviation of the actual energy consumption of the vehicle for travelling the route section from the calculated expected energy consumption of the vehicle required for travelling the route section. For example, if the statistical evaluation reveals that the actual respective energy consumption statistically significantly exceeds the anticipated energy consumption calculated for the vehicles respectively for traveling the route section, the estimated value corrects a calculated anticipated energy requirement upward accordingly. If, on the other hand, the statistical evaluation shows that the actual respective energy consumption is statistically significantly lower than the anticipated energy consumption for travelling the route section calculated for the vehicles in each case, the estimated value corrects a calculated anticipated energy requirement downward accordingly. The estimated value is thus determined statistically from so-called swarm data, which includes consumption data from a large number of vehicles.

In a further embodiment of the method according to the invention, a probability distribution for a deviation of an actual energy consumption of a vehicle for travelling the route section from a calculated expected energy consumption of the vehicle required for travelling this route section is determined during the statistical evaluation of the consumption data and additional data for one route section of the route network in each case.

In other words, a frequency distribution and, from this, a probability distribution for a deviation of an actual energy consumption of a vehicle for travelling the route section from a calculated expected energy consumption for travelling the route section are determined from the consumption data of a plurality of vehicles for one route section in each case. The estimated value for the correction of a calculated expected energy consumption is thus determined on the basis of a probabilistic analysis of the consumption data of a plurality of vehicles.

In a further embodiment of the method according to the invention, consumption data are weighted as a function of additional data for determining the probability distribution for a route section.

Weighting is used to assign a weight to each of the consumption data, with which they are included in the statistical analysis of the consumption data. For example, more recent consumption data can be given a higher weighting than older consumption data in order to give more recent and thus more up-to-date consumption data a greater influence on the result of the statistical analysis than older consumption data.

In a further embodiment of the method according to the invention, consumption data are transformed as a function of additional data for determining the probability distribution for a route section.

By means of a suitable transformation of consumption data, consumption data can be made more comparable or adapted to each other. For example, consumption data of a vehicle can be transformed as a function of a mass of the vehicle so that they correspond to a vehicle with a specified reference mass. In this way, an influence of the mass of a vehicle on its energy consumption can be compensated for in the statistical analysis of the consumption data.

In a further embodiment of the method according to the invention, if no sufficient amount of consumption data and additional data is available in the data cloud for a route segment, the consumption data and additional data used for determining the probability distribution for the route segment are replaced or supplemented by consumption data and additional data available for another route segment. For example, a route section similar to the route section for which there is no sufficient amount of consumption data and additional data in the data cloud is selected as the other route section.

The aforementioned embodiment of the method according to the invention takes into account the case that not enough consumption data and additional data are stored in the data cloud for a route section to be able to perform a statistically meaningful evaluation of this data. In this case, the data is replaced or supplemented by consumption data and additional data available for another route segment. To ensure that the added data correspond as closely as possible to the actual route section under consideration, a route section similar to the actual route section under consideration is preferably selected as the other route section. Of course, data for several other route sections can also be added.

In a further embodiment of the method according to the invention, the probability distribution for a route section is determined as a function of a time period in which the route section was travelled and/or of weather conditions and/or traffic conditions when the route section was travelled.

In the aforementioned embodiment of the method according to the invention, several probability distributions can be determined and evaluated for a route segment, in each case for a specific time period in which the route segment was travelled and/or for specific weather conditions and/or traffic conditions when the route segment was travelled. For example, a probability distribution is determined for a route section for traveling the route section at a peak traffic time and another probability distribution is determined for traveling the route section outside of a peak traffic time. In this way, an influence of the time period in which the route section was travelled and/or of weather conditions and/or traffic conditions when travelling the route section on the energy consumption can be taken into account.

In a further embodiment of the method according to the invention, the estimated value from the data cloud is transmitted to the vehicle and the calculated expected energy consumption of the vehicle required to travel the route section is corrected by an energy control device based on the estimated value.

In the aforementioned embodiment of the method according to the invention, the actual correction of the calculated expected energy consumption required for travelling the route section is thus not carried out in the data cloud, but by an energy control device of the vehicle on the basis of the estimated value.

In a further embodiment of the method according to the invention, the additional data relating to a vehicle describe a vehicle type of the vehicle, an energy control device of the vehicle, a software version of a software of the vehicle operated on a control device, in particular an energy control device, a load of the vehicle when travelling a route section and/or a time and/or a time interval of travelling a route section by the vehicle.

By taking such additional data into account, the estimated value for the deviation of the actual energy consumption of the vehicle for travelling the route section from the calculated expected energy consumption of the vehicle required for travelling the route section can be determined depending on the vehicle and/or the journey.

In a further embodiment of the method according to the invention, the estimated value describes a relative deviation of an actual energy consumption of the vehicle for travelling the route section from a calculated expected energy consumption of the vehicle required for travelling the route section.

The relative deviation of an actual energy consumption from a calculated expected energy consumption is understood to be the (normalized) deviation related to the calculated expected energy consumption, i.e. the deviation of the actual energy consumption from the calculated expected energy consumption divided by the calculated expected energy consumption. The use of the relative deviation as an estimated value has the advantage that the estimated value thus becomes largely independent of specific properties of the route section and the vehicle, such as a length of the route section and a mass of the vehicle.

According to the invention, the task is further solved with an energy consumption correction system for correcting an estimate of an energy consumption of a vehicle for travelling a route section of a route network Navigation device of a vehicle, which has:

a database which is set up to allocate route sections of the route network to consumption data and additional data transmitted into a data cloud, which in each case describe an expected energy consumption of the vehicle calculated for a vehicle for travelling in each case a route section and the actual energy consumption of the vehicle for travelling this route section, as well as additional data related to the vehicle,

an evaluation service which is set up to determine, in the data cloud for in each case one route section of the route network, a probability distribution for a deviation of an actual energy consumption of a vehicle for travelling the route section from a calculated expected energy consumption of the vehicle required for travelling this route section from the consumption data and additional data stored in the database,

an estimation service which is set up to determine, in the data cloud for a section of a route to be travelled by the vehicle in the route network, an estimated value for a deviation of the actual energy consumption of the vehicle for travelling the section of the route from a calculated estimated energy consumption of the vehicle required for travelling the section of the route, on the basis of the probability distribution determined for the section of the route, and

a computing unit which is set up to correct a calculated estimated energy consumption of the vehicle required for travelling the section of the route on the basis of the estimated value.

Such an energy consumption correction system makes it possible to carry out the method according to the invention. Therefore, the advantages of the energy consumption correction system result from the above-mentioned advantages of the method according to the invention.

### BRIEF DESCRIPTION OF THE DRAWINGS

Embodiments of the invention are explained in more detail below with reference to drawings. Thereby show:

FIG. 1 is block diagram of an embodiment of an energy consumption correction system according to the invention,

FIG. 2 is a flow chart of an embodiment of the process according to the invention,

FIG. 3 shows a route taken by a vehicle.

### DETAILED DESCRIPTION OF EXAMPLE EMBODIMENTS

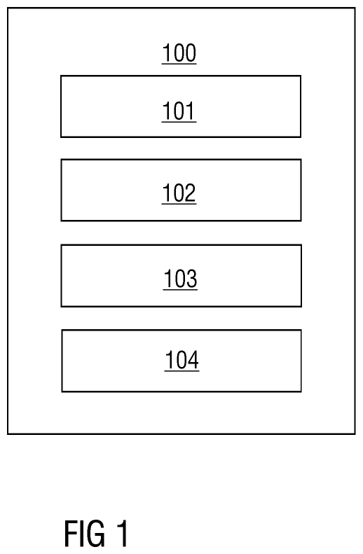

FIG. 1 shows a block diagram of an energy consumption correction system 100 for correcting an estimate of an energy consumption of a vehicle for traveling a section of a road network according to one embodiment of the invention. The energy consumption correction system 100 has the following functional units shown in FIG. 1: a database 101, an evaluation service 102, an estimation service 103, and a computing unit 104.

The database 101 is set up to associate route sections of the route network with consumption data and additional data transmitted to a data cloud, each of which describes an expected energy consumption of the vehicle calculated for a vehicle to travel a respective route section and the actual energy consumption of the vehicle to travel this route section, as well as additional data related to the vehicle.

The additional data related to a vehicle describe, for example, includes a type of the vehicle, an energy control device of the vehicle, a software version of a software of the vehicle operated on a control device, in particular an energy control device, a load of the vehicle when travelling a route section and/or a time and/or a time interval of travelling a route section by the vehicle.

The evaluation service 102 is arranged to determine, in the data cloud for a respective route section of the route network, a probability distribution for a deviation of an actual energy consumption of a vehicle for travelling the route section from a calculated expected energy consumption of the vehicle required for travelling this route section from the consumption data and additional data stored in the database 101.

The estimation service 103 is arranged to determine, in the data cloud for a route segment of a route to be traveled by the vehicle in the route network, an estimated value for a deviation of the actual energy consumption of the vehicle for traveling the route segment from a calculated expected energy consumption of the vehicle required for traveling the route segment, based on the probability distribution determined for the route segment.

The computing unit 104, having a processor circuit, is arranged to correct a calculated expected energy consumption of the vehicle required to travel the route section based on the estimated value.

For example, the database 101, the evaluation service 102, and the estimation service 103 are each implemented by a computer program executed in the data cloud. The computing unit 104 is, for example, is part of an energy control device of the vehicle.

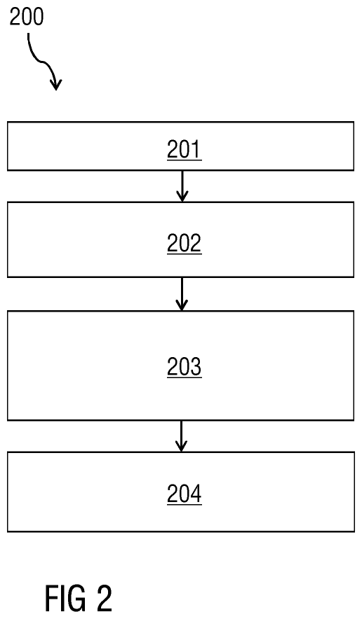

FIG. 2 shows a flowchart 200 of a method comprising method steps 201 to 204 for correcting an estimate of an energy consumption of a vehicle for traveling a section of a road network according to one embodiment of the invention. The method is carried out using an energy consumption correction system 100 described with reference to FIG. 1.

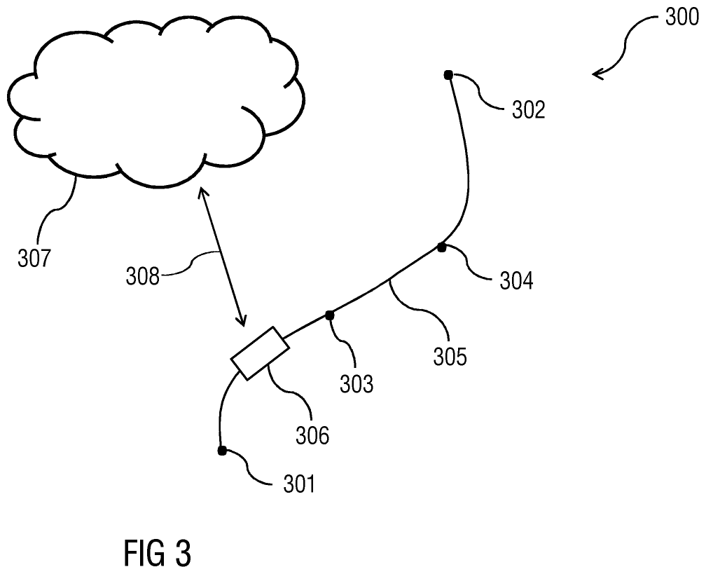

The process steps 201 to 204 are also described below with reference to FIG. 3.

FIG. 3 shows a travel route 300 traveled by a vehicle 306. The travel route 300 extends from a starting point 301 to an ending point 302. Also shown is a route section 305 of the travel route 300. The route section 305 extends from a first intermediate point 303 on the travel route 300 to a second intermediate point 304 on the travel route 300. The vehicle 306 communicates with a data cloud 307 via a radio link 308, such as a cellular connection.

In a first method step 201, an energy consumption expected to be required for the vehicle 306 to travel the section 305 of the route 300 is calculated.

In a second method step 202, the route 300 with the route section 305, the energy consumption calculated for the vehicle 306 that is expected to be required for travelling the route section 305, and additional data related to the vehicle 306 are transferred to the data cloud 307. The additional data describes, for example, a vehicle type of the vehicle 306, an energy control device of the vehicle 306, a software version of a software of the vehicle 306 operated on a control device, in particular an energy control device, a load of the vehicle 306, and/or a time and/or a time interval of the expected travel of the route section 305 by the vehicle 306.

In a third method step 203, the estimation service 103 determines, in the data cloud 307, an estimated value for a deviation of the actual energy consumption of the vehicle 306 for traveling the route section 305 from the calculated expected energy consumption of the vehicle 306 required for traveling the route section 305. The estimated value describes the estimated relative deviation of the actual energy consumption of the vehicle 306 for traveling the route section from the calculated expected energy consumption of the vehicle 306 required for traveling the route section.

The estimated value is determined by a statistical evaluation of consumption data of vehicles stored in the database 101 and additional data relating to these vehicles in each case. The consumption data each describes a calculated expected energy consumption of a vehicle required for travelling a route section of the route network and the actual energy consumption of the respective vehicle for travelling this route section. The additional data relating to a vehicle describe, for example, a vehicle type of the vehicle, an energy control device of the vehicle, a software version of a software of the vehicle operated on a control device, in particular an energy control device, a load of the vehicle when travelling a route section and/or a time and/or a time interval of travelling a route section by the vehicle.

In the statistical evaluation of the consumption data and additional data, a probability distribution for a deviation of an actual energy consumption of a vehicle for travelling the route section from a calculated expected energy consumption of the vehicle required for travelling this route section is determined by the evaluation service 102 for each route section of the route network.

To determine the probability distribution for a route segment, consumption data can be weighted depending on additional data, for example. For example, younger consumption data are weighted higher than older consumption data.

Furthermore, consumption data can be transformed as a function of additional data, for example. For example, consumption data of a vehicle are transformed as a function of a mass of the vehicle so that it corresponds to a vehicle with a specified reference mass.

Furthermore, if there are not a sufficient amount of consumption data and additional data in the data cloud 307 for a route segment, the consumption data and additional data used for determining the probability distribution for the route segment can be replaced or supplemented by consumption data and additional data available for another route segment. In this case, the other route section is, for example, a route section similar to the route section for which a sufficient amount of consumption data and additional data are not available in the data cloud 307.

Further, the probability distribution for a route segment may be determined as a function of a time period in which the route segment was traveled and/or weather conditions and/or traffic conditions when the route segment was traveled. For example, the weather conditions and/or traffic conditions are respectively obtained from a related information service of the data cloud 307 or another data cloud.

In a fourth method step 204, the calculated expected energy consumption of the vehicle 306 required for travelling the route section 305 is corrected by the computing unit 104 on the basis of the estimated value determined in the third method step 203. For this purpose, the estimated value is transmitted from the data cloud 307 to the vehicle 306 and fed to the computing unit 104.

### LIST OF REFERENCE NUMBERS

100 Energy consumption correction system
101 Database
102 Evaluation service
103 Estimation service
104 Calculation unit
200 Flowchart
201 to 204 Procedural step
300 Driving route
301 Starting point
302 Endpoint
303 First intermediate point
304 Second intermediate point
305 Route section
306 Vehicle
307 Data cloud
308 Radio connection

1. A method for correcting an estimate of an energy consumption of a vehicle (306) for traveling a section (305) of a route network, comprising:
calculating an energy consumption expected to be required for the vehicle (306) to travel the section (305) of a route (300) by the vehicle (306) in the route network,
transferring the route (300) and additional data related to the vehicle (306) to a data cloud (307),
determining, in the data cloud (307), an estimated value for a deviation from the actual energy consumption of the vehicle (306) for traveling the route section (305) from the calculated expected energy consumption of the vehicle (306) required for traveling the route section (305), and
correcting the calculated expected energy consumption of the vehicle (306) required for travelling the route section (305) based on the estimated value.

2. The method according to claim 1, wherein the estimated value for the deviation of the actual energy consumption is determined by a statistical evaluation of consumption data of vehicles transmitted into the data cloud (307) and the additional data related to these vehicles in each case, wherein the consumption data comprises in each case a calculated energy consumption of a vehicle expected to be required for travelling a route section (305) of the route network and the actual energy consumption of the respective vehicle for travelling this route section (305).

3. The method according to claim 2, further comprising: determining a probability distribution for a deviation of an actual energy consumption of a vehicle for travelling the route section (305) from a calculated expected energy consumption of the vehicle required for travelling this route section (305) during the statistical evaluation of the consumption data and the additional data for a respective route section (305) of the route network.

4. The method according to claim 3, wherein for the determination of the probability distribution for a route section (305) consumption data are weighted in dependence on additional data.

5. The method according to claim 3, wherein for determining the probability distribution for a route section (305) consumption data are transformed in dependence on the additional data.

6. The method according to claim 3, wherein, if a sufficient amount of consumption data and additional vehicle data is not available in the data cloud (307) for a route segment (305), the consumption data and additional vehicle data used for determining the probability distribution for the route segment (305) are replaced or supplemented by consumption data and additional data available for another route segment.

7. The method according to claim 6, further comprising selecting, as another route section, a route section similar to the route segment (305) for which a sufficient amount of consumption data and additional data is not available in the data cloud (307).

8. The method according to claim 3, wherein the probability distribution for a route section (305) is determined as a function of a time period in which the route section (305) was travelled and/or weather conditions and/or traffic conditions when the route section (305) was travelled.

9. The method according to claim 1, wherein the estimated value from the data cloud (307) is transmitted to the vehicle (306) and the calculated expected energy consumption of the vehicle (306) required for travelling the route section (305) is corrected by an energy control device based on the estimated value.

10. The method according to claim 1, wherein the additional data relating to a vehicle (306) describes a type of the vehicle (306), an energy control device of the vehicle (306), a software version of a software of the vehicle (306) operated on an energy control device, a loading of the vehicle (306) when travelling a route section (305) and/or a time and/or a time interval of travelling a route section (305) by the vehicle (306).

11. The method according to claim 1, wherein the estimated value describes a relative deviation of an actual energy consumption of the vehicle (306) for traveling the route section (305) from a calculated expected energy consumption of the vehicle (306) required for traveling the route section (305).
